(19) United States
(12) Patent Application Publication
(10) Pub. No.: US 2010/0154728 A1
(43) Pub. Date: Jun. 24, 2010

(54) Process and Device for Generating Gas From Carbonaceous Material

(75) Inventors: Jörg Kemper, Remscheid (DE); Frank Lohmann, Emsdetten (DE)

Correspondence Address: HUDAK, SHUNK & FARINE, CO., L.P.A., 2020 FRONT STREET, SUITE 307, CUYAHOGA FALLS, OH, 44221, US

(73) Assignee: NATIVE POWER SOLUTIONS GMBH & CO. KG, Emsdetten (DE)

(21) Appl. No.: 12/223,835

(22) PCT Filed: Feb. 16, 2007
(86) PCT No.: PCT/EP2007/001346

§ 371 Date: Aug. 11, 2008

(30) Foreign Application Priority Data
Feb. 17, 2006 (DE) 10 2006 007 458

(51) Int. Cl. F02B 43/00; B01J 19/12; H02K 7/18

(52) U.S. Cl. 123/3; 204/157.43; 422/186.04; 290/1 A

(57) ABSTRACT

To gasify carbonaceous material into gas containing CO and H₂, the drying and/or the heating and the pyrolysis of the carbonaceous material are performed using microwave irradiation and thermal irradiation and the pyrolysis products and/or the carbonaceous material are then gasified. For this purpose the carbonaceous material is irradiated in a microwave station with a heating unit, and then passed on into a reactor for gasification. The gasification occurs with the aid of a water-steam plasma source.

### FIELD OF THE INVENTION

The present invention relates to a method and a device for generating gas containing CO and H₂ from carbonaceous material. Furthermore, the invention relates to a device for generating electrical energy using pyrolysis and gasification of carbonaceous materials into gas containing CO and H₂ having a gasification reactor, an engine driven with the aid of the gas containing CO and H₂, and a power generator driven by the engine.

### BACKGROUND OF THE INVENTION

With the background of decreasing resources of fossil fuels, decentralized power supply on the basis of waste or biomass from renewable raw materials receives ever more significance. Heat is generated in biomass or waste combustion, which may be used for heating buildings or water, for example. In gasification, combustion gas which may be used in engines for power generation is generated in addition to heat.

Gasification is generally executed in multiple steps: drying/heating for preparation, pyrolysis, and gasification, namely the reaction of the pyrolysis products by oxidation and reduction. The resulting gas contains, inter alia, hydrogen, carbon monoxide, and methane, which may be used as fuel. The composition of the resulting gas is a function of the reaction gas used and the temperature at which the gasification occurs. At higher temperatures, the concentration of hydrogen and carbon monoxide increases and the concentration of methane decreases.

The higher the temperature, the lower the probability that the resulting gas will still contain toxic or carcinogenic components such as dioxin or tar. This is because at temperatures of 900° C. and higher, they are cleaved into harmless volatile substances such as carbon dioxide and hydrogen. One possibility for providing high temperatures of 900° C. and more is offered by the use of a plasma burner.

A method and a facility for the gasification of carbonaceous material into a gas mixture primarily comprising CO and H₂ is known from DE 32 33 774 A1, in which the carbonaceous material is introduced in piece form into a shaft furnace up to a predefined filling height. The shaft furnace has plasma burners on the floor. In addition to heat energy from the plasma burners, oxidant is also supplied in the form of O₂, CO₂, or H₂O. The carbonaceous material is therefore subjected to a high temperature under oxidative conditions. The volatile components are thus released and react with the oxidant. The nonvolatile part, in contrast, is coked. Oxidant which has not reacted with the volatile components may react further down in the shaft furnace with the coke generated and form additional CO and possibly H₂O, CO₂ and H₂O escaping upward may react with the carbonaceous material falling downward to form CO and H₂. The gas leaving the shaft furnace has a temperature of at most 1500° C. The temperature may reach approximately 2000° C. on the surface of the grainy material in the shaft furnace.

### SUMMARY OF THE INVENTION

One object of the present invention is to provide a method and a device in which the carbonaceous material is pretreated.

This object is achieved by a method for the gasification of carbonaceous material into gas containing CO and H₂ having upstream pyrolysis, in which the pyrolysis of the carbonaceous material is performed with the aid of microwave radiation and by heating the carbonaceous material, and a gasification of the pyrolysis products is performed allothermally with the aid of a water-steam plasma.

By coupling energy into the carbonaceous material via microwaves, the carbonaceous material is completely penetrated with little effort and is rapidly heated from the inside to the outside. In addition, with carbonaceous material containing moisture, it is sufficiently dried and the moisture is converted into water steam, which is then available as an oxidant during the gasification. Because the carbonaceous material is heated from the inside to the outside, combustion is suppressed and instead the carbonaceous material is pyrolytically cleaved into volatile carbon compounds and nonvolatile carbon compounds having shorter carbon chains. The carbonaceous material may be preheated or heated after or in parallel to the microwave radiation by conventional heating means from the outside to the inside. The time required for the most complete possible pyrolysis is reduced and the energy balance of the overall process is improved as a whole by the heat introduction occurring from the inside to the outside and the outside to the inside. The pyrolysis products are used hereafter as educts for the gasification, which runs more rapidly and efficiently because of the pyrolysis which has already been at least partially performed.

A significant advantage of the method according to the invention is that it may be used especially well even in small-dimensioned facilities for decentralized power supply. This is because due to the pretreatment using microwaves, for example, even household waste or biomass in the form of garden waste may be used without complex prior preparation. Namely, the drying and heating and the pyrolysis are largely or completely achieved by the microwave irradiation. A heating unit for supporting the pyrolysis may also be provided with only a small space requirement.

Depending on the processing parameters, in particular temperature and reaction partner, autothermal or allothermal gasification may be performed. To ensure the most complete possible gasification, the gasification is performed here with the aid of external heat introduction, specifically by a plasma. This is because temperatures may be achieved without problems with the aid of a plasma at which it is ensured that residues of tar or compounds hazardous to health are also cleaved and converted into CO and H₂ in particular. A water-steam plasma is used according to the invention. It comprises O—, H—, OH—, O₂—, H₂O—, and H₂O-radicals, which react very well with the pyrolysis products and carbonaceous material which has possibly not yet been pyrolyzed. In addition, the enthalpy density of water-steam plasma is very high. These properties result in an acceleration of the gasification process. Because additionally the thermal efficiency of water-steam plasma sources is from 70-90%, the use of water-steam plasma is cost-effective in operation. The use of both pure water-steam plasma and also plasma made of water steam with additives or gas mixtures with water steam as a reaction accelerator are advantageous.

In a preferred embodiment, a pore burner is used for heating during the pyrolysis. Pore burners are especially well suitable because they provide a very high power density and may additionally be operated using synthesis gas produced according to the present invention, which is still hot. This results in an improved overall energy balance of the method.

In a very especially preferred embodiment, the gasification immediately follows the pyrolysis. The pyrolysis products may thus be treated further by gasification before they cool off, so that they may be brought to the processing temperature for the gasification in minimal time. This improves the overall energy balance of the method. Moreover, in comparison to typical methods, because of the use of a water-steam plasma for the gasification and the especially efficient pyrolysis by the combination of microwave irradiation and thermal irradiation, a complex material stream separation into solid and volatile pyrolysis products may be dispensed with.

In a preferred embodiment, the pyrolysis products and/or the carbonaceous material and/or gasification products are at least partially subjected more than once to an external heat introduction in the form of a water-steam plasma. The efficiency of the gasification process is thus increased. Material particles, whether they are pyrolysis products or possibly not yet reacted starting products made of carbonaceous material, which were not completely gasified during the first passage through a zone having external heat introduction, are gasified upon a further passage through such a zone. In addition, they enhance the heat transfer to newly supplied material particles, by which the gasification efficiency also increases. The particles may be guided via a fan or mechanically in such a way that they are again subjected to the external heat introduction. If a plasma source is used to generate the external heat introduction, they are preferably suctioned toward the plasma while exploiting a nozzle effect. They thus come directly into the hot plasma flame, whereby a strong volume enlargement of the gaseous components results. This volume enlargement results in an acceleration in the direction of further pyrolysis products and/or carbonaceous material leaving the microwave irradiation. The components coming from the plasma flame mix with the components newly coming from the microwave irradiation, heat them rapidly, and accelerate the gasification process.

It has proven to be advantageous to compact the carbonaceous material before and/or during and/or after the microwave irradiation. The compaction results in more efficient energy introduction by microwave irradiation and/or heat irradiation and is preferably performed before the microwave irradiation and/or possibly the heat irradiation. The most complete possible pyrolysis of the carbonaceous material by the microwave irradiation is thus achieved.

In particular, but not only if the carbonaceous material has been compacted, the pyrolysis products and/or the carbonaceous material are advantageously comminuted after the microwave irradiation. The surface of the material to be gasified is thus enlarged, which results in a further acceleration of the gasification process. The overall energy balance is additionally improved. This is because, in contrast to the comminutation of the starting material before the pyrolysis, for which quite a large amount of energy is required in certain circumstances, the solid pyrolysis products, which are largely carbon, may be comminuted with relatively little effort and energy.

In a further aspect of the present invention, the object is achieved by a device for the gasification of carbonaceous material into gas containing CO and H₂, which has at least one microwave station and one heating unit to at least partially perform the pyrolysis of the carbonaceous material, as well as a first reactor having at least one water-steam plasma burner to perform the gasification. As an advantageous side effect, not only are the molecular structures broken, but by the microwave and heat irradiation the carbonaceous material is dried and/or heated as needed in the microwave station. The pyrolysis products are then converted especially energy efficiently in the water-steam plasma into synthesis gas having a high hydrogen component. This is because if water-steam plasma burners are used, sufficient oxidant is also provided with the plasma in addition to the heat energy.

In an especially preferred embodiment, the microwave station or the heating unit is situated in the process flow direction directly before the first reactor. This not only increases the energy balance of the device, but rather also allows an especially compact design of the device, so that it is also well suitable for decentralized power supply.

The microwave station is preferably situated in a second reactor for the purpose of optimized pyrolysis on one hand and optimized gasification on the other hand.

The microwave station advantageously has a compaction unit. Depending on the embodiment, the compaction unit may be connected upstream from the microwave station and/or the heating unit, integrated therein, or connected downstream therefrom. Integration in the microwave station suggests itself in particular if irradiation using microwaves and/or heating by radiant heat and compaction are to be performed simultaneously. The compaction unit in particular allows a more compact construction of the microwave station, which may be thermally insulated with less effort.

The heating unit is especially preferably implemented as a pore burner. In addition to the energy introduction via microwave irradiation, more efficient heat introduction by heat radiation is thus ensured, which acts from the outside to the inside on the material to be pyrolyzed, supplementing the action of the microwave irradiation from the inside to the outside. In contrast to conventional burners, such as gas burners, significantly higher temperatures may be achieved using pore burners, resulting in a heat introduction which is multiple times higher.

A mixing unit is advantageously situated in the first reactor. It is used to mix the content already present in the first reactor with the content added from the microwave station and/or the heating unit. The added content is thus brought more rapidly to gasification temperature and the gasification process is accelerated. The mixing unit is preferably implemented as a rotatable screen drum which additionally screens out the ashes.

In a preferred embodiment, a comminuting unit is situated in the first reactor or at the outlet of the microwave station and/or the heating unit. It is used to comminute the solid pyrolysis products and/or the carbonaceous material after the microwave irradiation. Their surface is thus enlarged and the gasification is accelerated. The pulverizing unit is preferably implemented as a scraping unit which abrades the surface of the pyrolysis products and/or the carbonaceous material which exit from the microwave station or heating unit. The scraping unit delivers the gasification processing temperature during the scraping procedure by direct contact on the freshly scraped point of the abraded material. In this way, the energy introduction into the material particle is accelerated. In addition, a cracked surface results due to the scraping procedure, because of which further enlargement of the gasification surface occurs. The comminuting device is especially preferably situated on the screen drum, so that the abraded particles are immediately mixed with the reactor content already present by the movement of the screen drum.

In a preferred embodiment, the at least one water-steam plasma burner is attached to the first reactor in such a way that its plasma flame does not or only partially extends up into the reactor inner chamber, and an additional duct leads from the first reactor to the plasma flame. The reactor content is thus sucked toward the plasma flame, which is accelerated into the reactor by strong heating and volume enlargement of the gaseous component thus caused. In the plasma flame itself, a material component is gasified into CO and H₂ in particular, and the mixing in the reactor inner chamber is encouraged by the acceleration of the material into the reactor inner chamber and the gasification process is thus accelerated. Because gas-particle mixture is permanently suctioned out of the reactor inner chamber through the additional line toward the plasma flame in a type of nozzle effect, a continuous gasification process is maintained. The advantage of this air circulation system is not only that the gasification process runs significantly more rapidly and the dwell time of the material is thus shortened. The reactor chamber may also be dimensioned significantly smaller, which has the result that the insulation losses are strongly reduced and the overall efficiency increases. The flow of the material may also be maintained mechanically or with the aid of a fan or support the nozzle effect.

Furthermore, the object is achieved by a device for generating electrical energy using pyrolysis and gasification of carbonaceous materials into gas containing CO and H₂ having a gasification reactor, an engine driven with the aid of the gas containing CO and H₂, and a power generator driven by the engine, at least one microwave station and one heating unit being connected upstream from the gasification reactor, in which the carbonaceous material is at least partially pyrolyzed using microwave irradiation and thermal irradiation, and the gasification reactor has a water-steam plasma burner as a heat source. By coupling such a device for the gasification of carbonaceous material into gas containing CO and H₂ to an engine which uses the generated gas containing CO and H₂ for power generation, without great preparation effort and energy efficiently, carbonaceous materials such as household waste, biowaste, garden waste, pellets, inter alia or also industrial waste may not only be converted into heat energy and chemical energy, which is stored in the gas containing CO and H₂, but rather also directly into electrical energy.

The heating unit is advantageously implemented as a pore burner.

In an especially preferred embodiment, the microwave station or the heating unit is situated in the process flow direction directly before the first reactor.

In a preferred embodiment, a hot gas burner is connected upstream from the engine and the engine is implemented as a Stirling engine. In this way, the generated gas may be used further immediately without complex cooling, which would be necessary in typical gas engines, by which the overall efficiency of the device for generating electrical energy is increased. In addition, Stirling engines have the advantage of being relatively low vibration, so that the noise load is correspondingly low. This encourages use in particular in smaller buildings or living units.

The hot gas burner is preferably implemented as a pore burner. This has the advantage that the permitted intake temperature of the gas is still so high that interfering contaminants such as tar are still in the volatile state. The effort for cleaning the generated gas may thus be reduced to a minimum, which allows an especially compact and energy-efficient construction of the device for generating electrical energy.

### BRIEF DESCRIPTION OF THE DRAWINGS

The present invention is to be explained in greater detail with reference to a preferred exemplary embodiment. In the figures:

FIG. 1 shows a perspective view of a first embodiment of a device for gas generation;

FIG. 2 shows a horizontal section through the device from FIG. 1;

FIG. 3 shows a vertical section in the longitudinal direction through the device from FIG. 1 in a simplified view;

FIG. 4 shows a vertical section perpendicular to the longitudinal direction through the device from FIG. 1 in a simplified view;

FIG. 5 shows a schematic detail view of a first embodiment of a scraping unit;

FIG. 6 shows a schematic detail view of an air circulation channel;

FIG. 7 schematically shows the material flow of a gasification;

FIGS. 8a,b show a schematic detail view of a second embodiment of a scraping unit from the side and in a top view;

FIG. 9 shows a horizontal section through a device as in FIGS. 1 through 4 having the scraping unit from FIGS. 8a,b;

FIGS. 10a,b show a schematic illustration of a special embodiment of the scraping unit from FIGS. 8a,b;

FIGS. 11a,b,c show views of a further embodiment of a device for power generation in perspective from the front and the rear and from the side;

FIG. 12 shows a section through a further embodiment of a device for gas generation;

FIG. 13 shows a perspective view of a third embodiment of a device for gas generation;

FIG. 14 shows a horizontal section through a device as in FIG. 13;

FIG. 15 shows a vertical section in the longitudinal direction through the device from FIG. 13 in a simplified view;

FIG. 16 shows a vertical section through the device from FIG. 13 at the height of the pore furnace for the pyrolysis;

FIG. 17 shows a horizontal section through a device as in FIG. 13 having the scraping unit from FIGS. 8a,b; and

FIG. 18 shows a vertical section perpendicular to the longitudinal direction through the device from FIG. 10 in a simplified view.

### DETAILED DESCRIPTION OF THE INVENTION

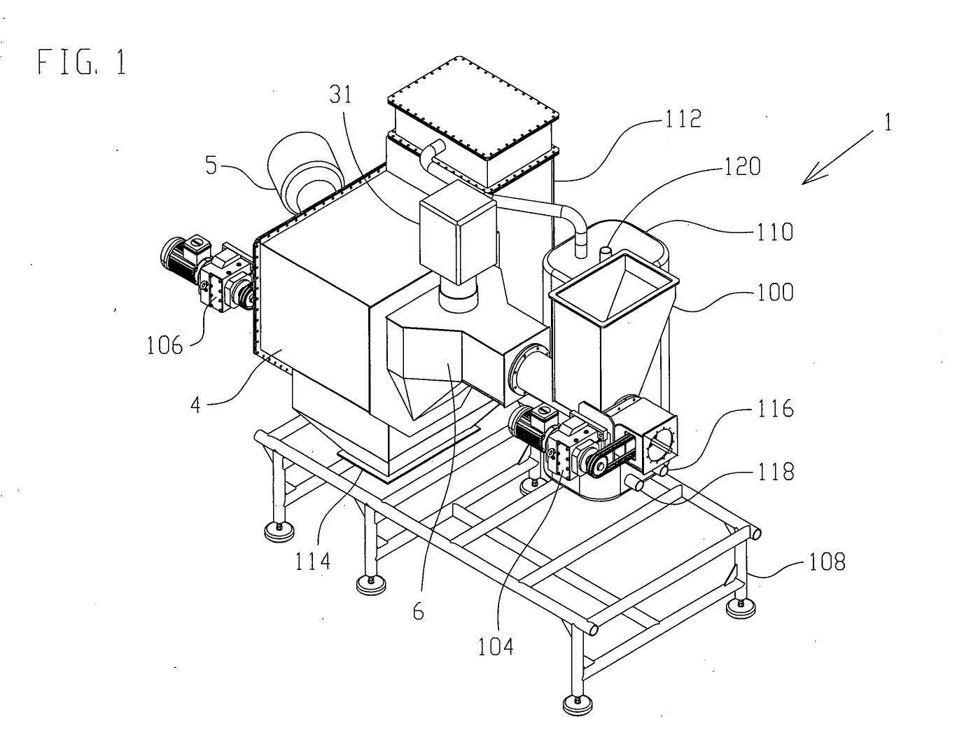

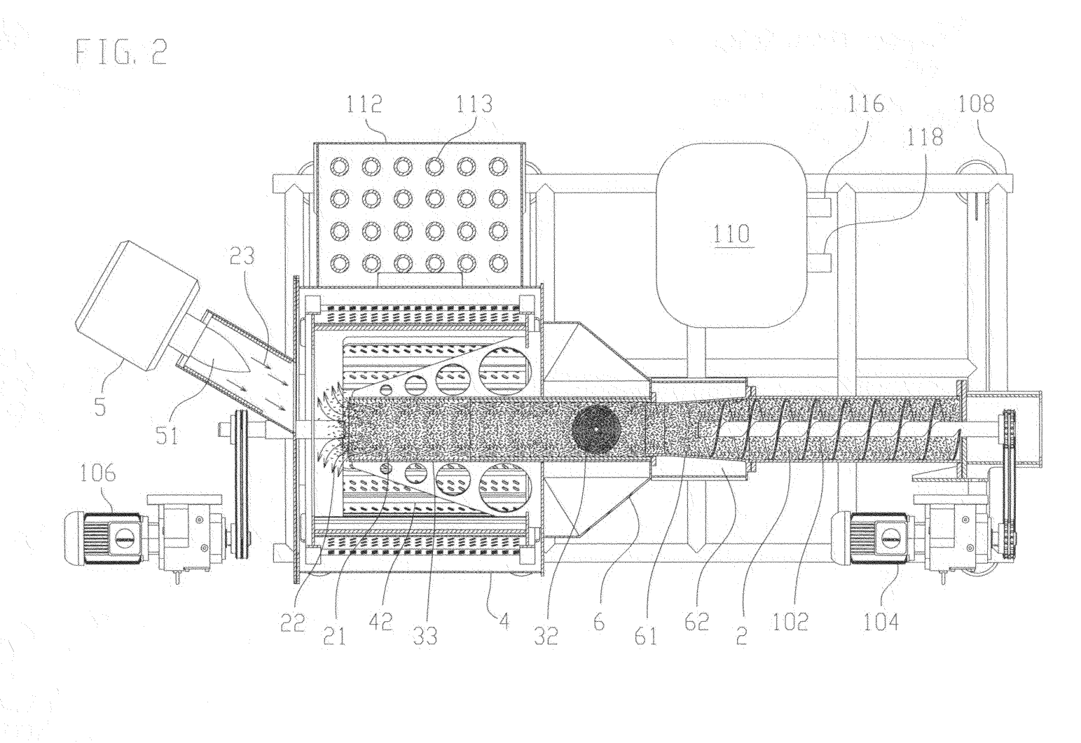

FIG. 1 shows a gas generator 1 on a facility 108, which is designed for a power of approximately 100 kWₑₗ (net). The starting material may be industrial waste or household waste or biomass based on renewable raw materials, such as garden waste, wood chips, preferably of a grain size of approximately 6-20 mm, sawdust, pellets, peelings, husks, or straw. Fossil fuels may also be gasified in the gas generator.

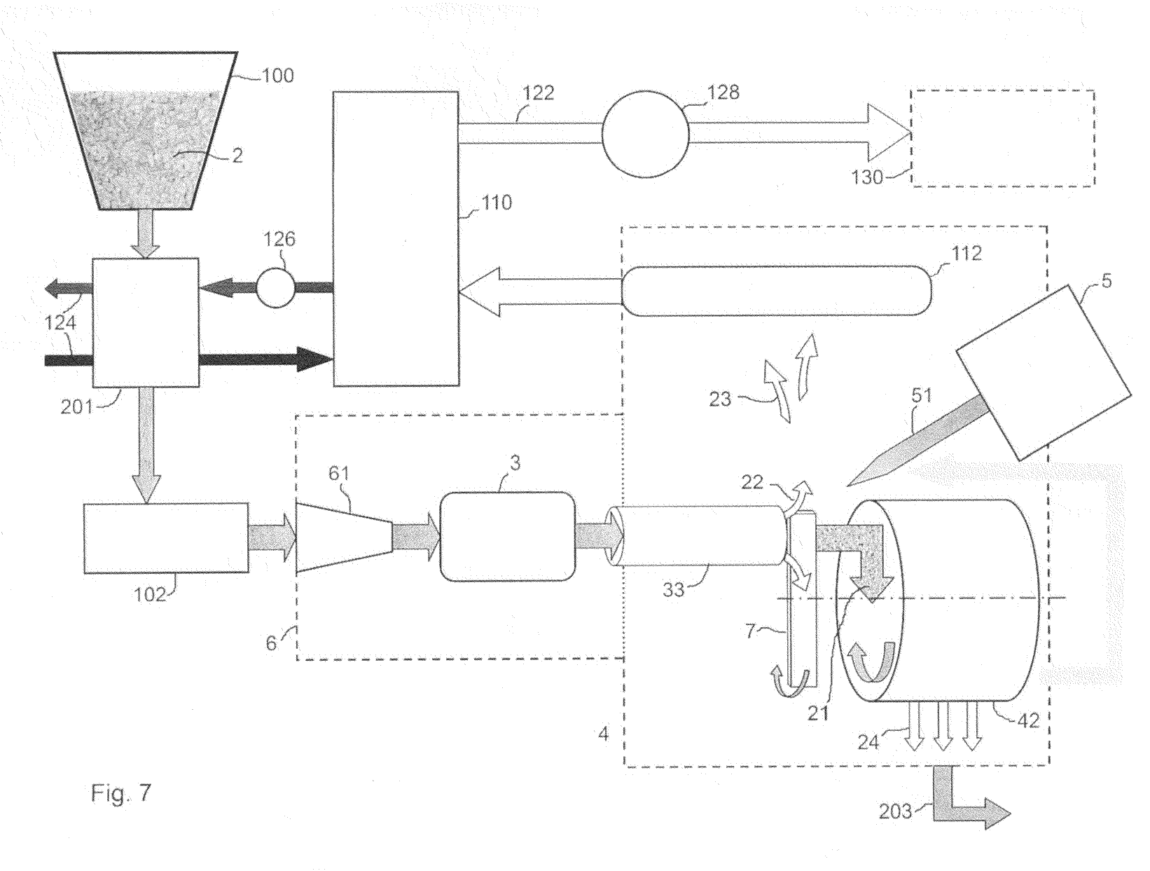

The carbonaceous material is poured in via the funnel 100. The carbonaceous material 2 may already be preheated therein to approximately 60°-80° C. using the waste heat of a gas cooler 10 in the form of a heat exchanger, possibly combined with a gas washer (see also reference numeral 201, FIG. 7).

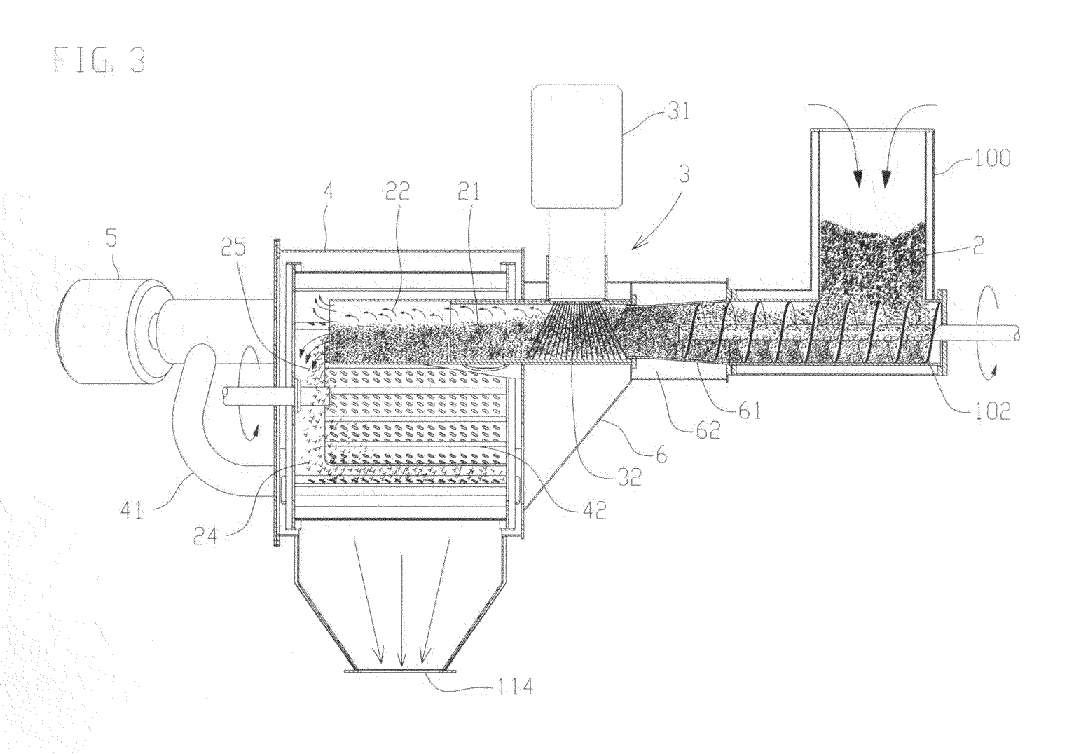

The carbonaceous material 2 is conveyed further into a secondary reactor 6 with the aid of transport screw 102 (see also FIGS. 2, 3) having drive 104. The carbonaceous material 2 is heated to approximately 400-500° C. therein. This is predominantly performed via microwaves which are generated in the microwave generator 31, and a heating device 62, which uses the waste heat of the primary reactor 4 in which the gasification occurs, or is externally supplied with energy, e.g., as an electrical furnace, or uses a combination of internal and external energy. The heating device 62 is attached to the reactor 6 and connected upstream from the microwave generator 31.

In addition, the carbonaceous material 2 is guided through a squeezing part 61 enclosed by the heating device. 62. The squeezing part is implemented as conical, the cross-section tapering in the conveyance direction. The carbonaceous material 2 is thus compacted airtight before the microwave zone 32.

The carbonaceous material 2 is heated from the outside to the inside by the heating device 62. The carbonaceous material 2 is penetrated and heated from the inside to the outside by the microwave irradiation in the microwave station 3. This combination of supplied, radiant heat and microwave irradiation results in the best possible heat introduction into the carbonaceous material 2.

The carbonaceous material 2 is also dried by the heat introduction. This is advantageous in particular for starting materials which are not pretreated further, such as industrial or household waste or garden waste, but also in general for biomass made of renewable raw materials. The gas generator 1 is therefore insensitive even to larger variations in the moisture content of the carbonaceous material 2. The moisture exits from the carbonaceous material 2 as water steam and is used as an oxidant in the gasification process.

The high heat introduction, in particular into the interior of the carbonaceous material 2 by the microwave irradiation, triggers the pyrolysis of the carbonaceous material 2. During the pyrolysis, inter alia, the longer-chain molecules of the carbonaceous material 2 are cleaved into shorter molecules. Volatile and nonvolatile pyrolysis products form, which are used as educts for the following gasification. To implement the energy introduction by microwave irradiation as more targeted, the carbonaceous material 2 is guided through a feed pipe 33, so that all of the carbonaceous material 2 is guided through the microwave zone 32. In particular if pellets or comparable biomaterial are used as the starting material 2, the molecular structures are simply broken by the microwave irradiation, because of which the pyrolysis runs more efficiently. It is ensured by the airtight compaction in the squeezing part 61 before the microwave zone 32 that as little nitrogen as possible enters from the surrounding air, which would reduce the combustion value of the generated gas containing CO and H₂.

The dimensioning of the microwave generator 31 is a function in particular of the extension of the microwave zone 32, the density of the carbonaceous material 2, and the desired temperature. The selection of the frequency may be restricted by national guidelines. For example, in Germany only the frequencies 24.25 GHz, 5.8 GHz, 2.45 GHz, and, in special cases, 915 MHz are permitted for microwave heating. Instead of one microwave generator, two, three, or more may also be used, so that they are able to form either a coherent microwave zone or multiple separate microwave zones.

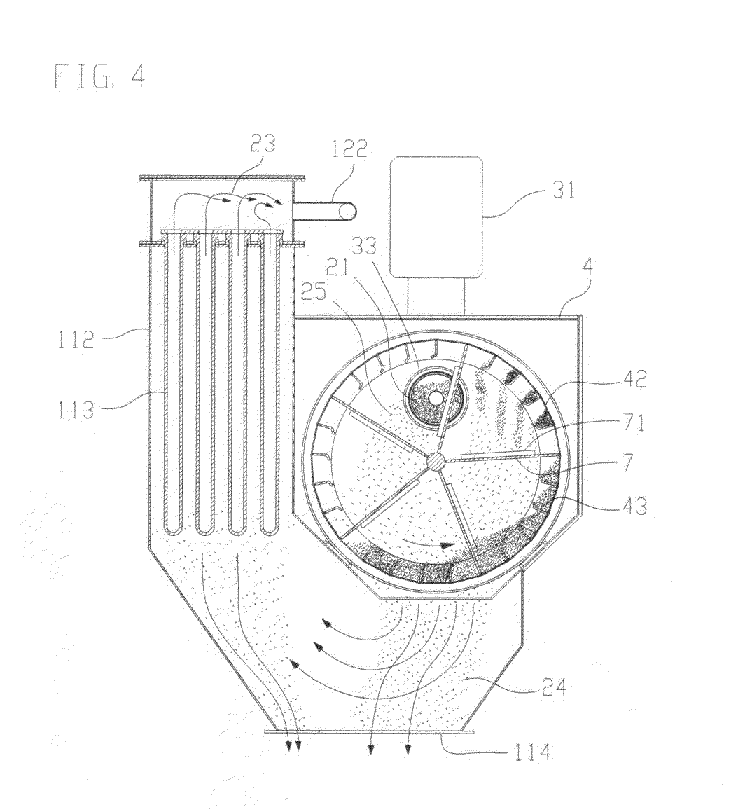

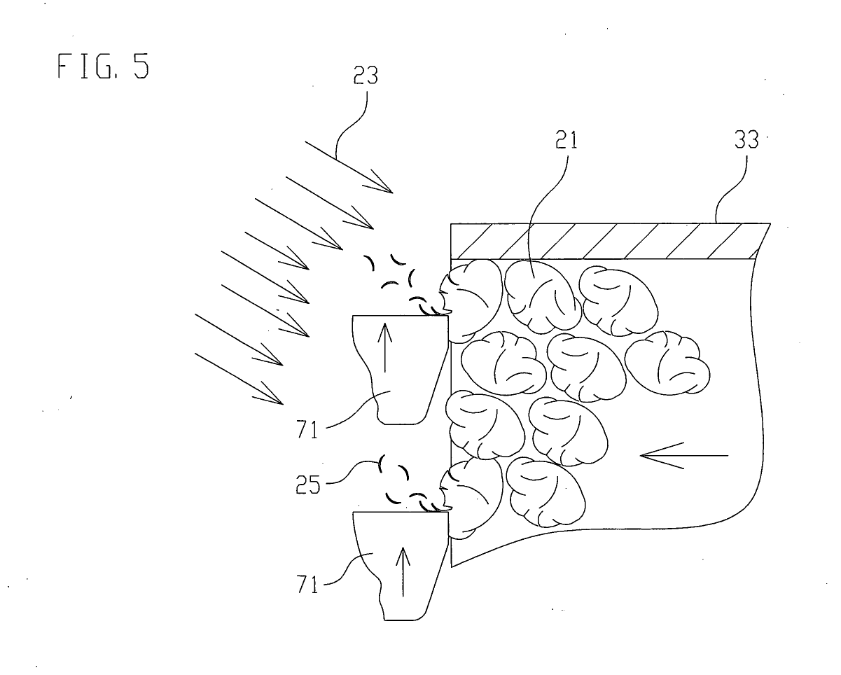

The feed pipe 33 leads into the primary reactor 4, into which a plasma burner 5 also opens and in which the gasification occurs. The feed pipe 33 leads through a screen drum 42 situated in the primary reactor 4. The screen drum 42 is mounted so it is rotatable around its longitudinal axis and is rotated via the drive 106. The longitudinal axis of the screen drum 42 is parallel to the feed pipe 33 in the present example. Screen drum panels 43 are situated on the interior of the peripheral wall of the screen drum 42 (see FIG. 4 in particular). In addition, a scraping unit 7, in the form of five blades 71, is attached on the side of the screen drum 42 facing toward-the plasma burner 5, which is carried along with the screen drum 42, guided past the outlet of the feed pipe 33 and abrades the surface of the exiting material, i.e., the nonvolatile pyrolysis products 21 and possibly the starting material 2 which has not yet been completely pyrolytically reacted, because of which small particles 25 arise (see also FIG. 5). In particular the material which has already been completely pyrolyzed is very friable, so that it may be crushed easily. In addition to the surface enlargement by particle formation per se, the procedure of scraping results in a cracked and therefore especially large surface, which is available for the gasification process, because of which the gasification process may run much more rapidly and efficiently.

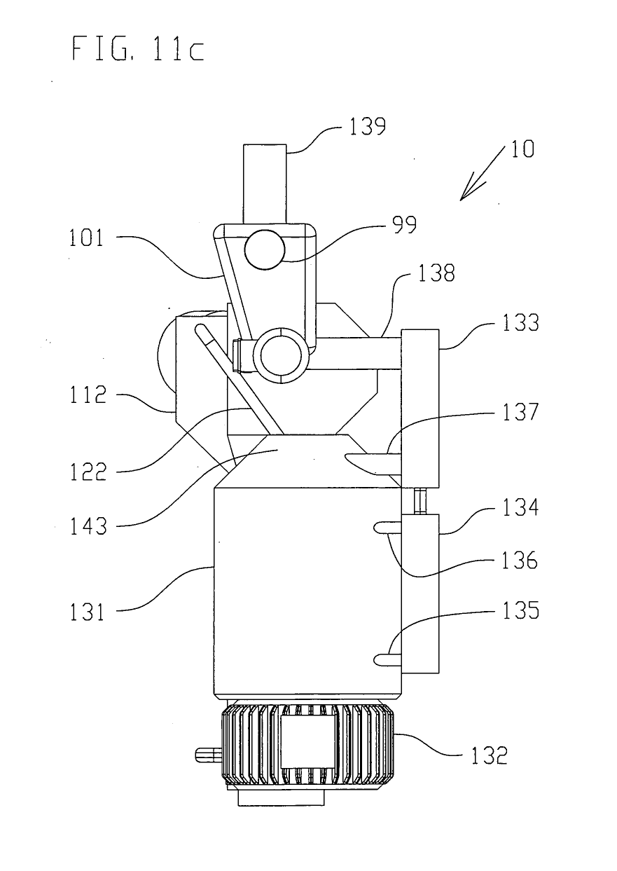

FIG. 12 shows a section through a further embodiment of a gas burner, specifically perpendicularly to the feed pipe 33. In this example, the microwave station is combined with a pore burner 63 for more intensive pyrolysis, which adjoins the microwave generator 31 and it is adapted in its geometry in such a way that it encloses the feed pipe 33. Because pore burners are made of ceramic, their geometries may be selected relatively freely. The present configuration having the pore burner 63 enclosing the feed pipe 33 is advantageous, inter alia, because of the small space requirement. In that the pore burner 63 projects into the reactor 4 or alternately is also situated entirely in the reactor 4, it contributes to warming up the reactor 4, in particular in the starting phase of the gasification procedure. The pore burner 63 may be fired using gas containing CO and. H₂ generated in the gas generator. Because pore burners allow very high gas temperatures, gas generated during the gasification procedure may be fed thereto immediately without prior cooling, possibly after dust filtering. In the example shown in FIG. 12, the pore burner 63 achieves six times as high a heat introduction as a typical gas burner. Overall, the use of a pore burner in combination with the microwave pyrolysis improves the total energy balance of the gas burner while still requiring little space and is therefore suitable in particular also for gas generators which are dimensioned for household use.

Opposite to the outlet of the feed pipe 33, the hot gas flow 23 of the plasma burner 5 opens into the primary reactor 4. The abraded particles 25 are therefore subjected directly to the high gas flow 23. In addition, the blades 71 of the scraping unit 7 continuously pass through the hot gas flow 23, so that they also have the processing temperature of approximately 950°-1050° C. and deliver this temperature to the supplied pyrolysis products 21 and possibly the carbonaceous material 2 by the direct contact during abrasion. The particles 25 are therefore at processing temperature in a very short time and may be gasified. It is ensured by the temperature of 950° C. or more in the gasification zone that carbon compounds which are harmful to health and tar are also gasified. as completely as possible and the content of CO and H₂ in the gasification product is additionally as high as possible.

Turbulence exists in the hot gas flow, which results in rapid mixing of the abraded particles with the remaining reactor content, i.e., with the reaction partners for the gasification. The gasification thus occurs more rapidly and intensively, by which the overall efficiency is increased. Particles 25 which fall in the reactor inner chamber and are removed from the hot gas flow 23 are captured by the screen drum 42 in its panels 43, transported back to the hot gas flow, and shaken therein into the hot gas flow, so that they are again better available for gasification. The entire reactor content is continuously circulated, which further enhances the gasification.

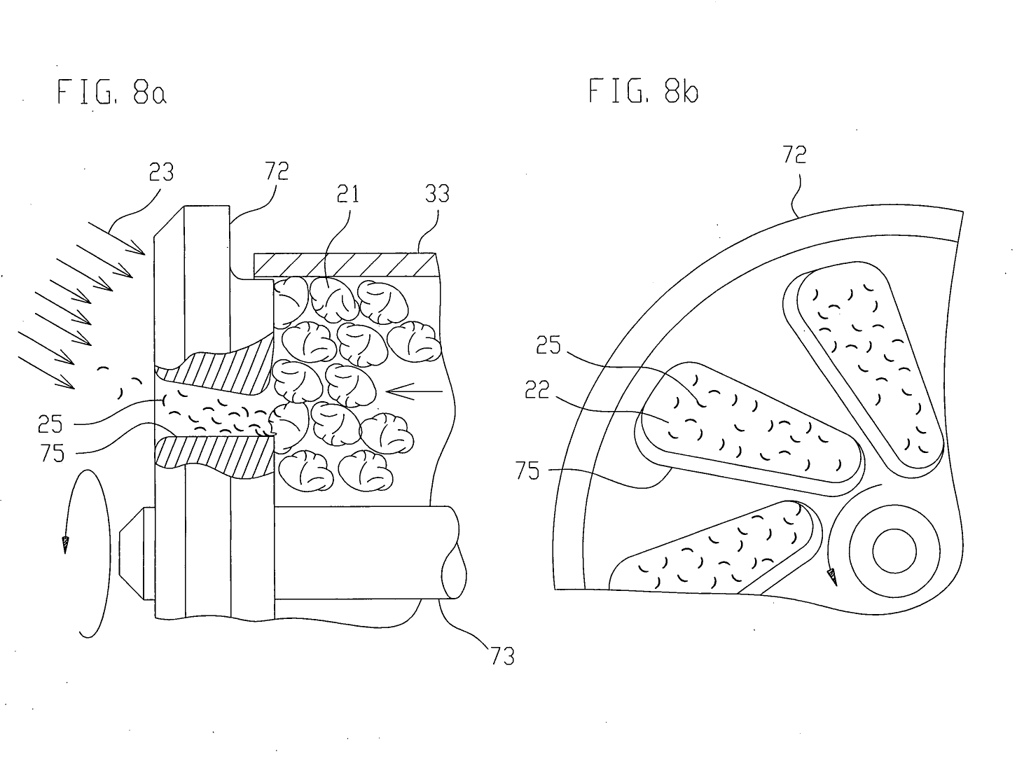

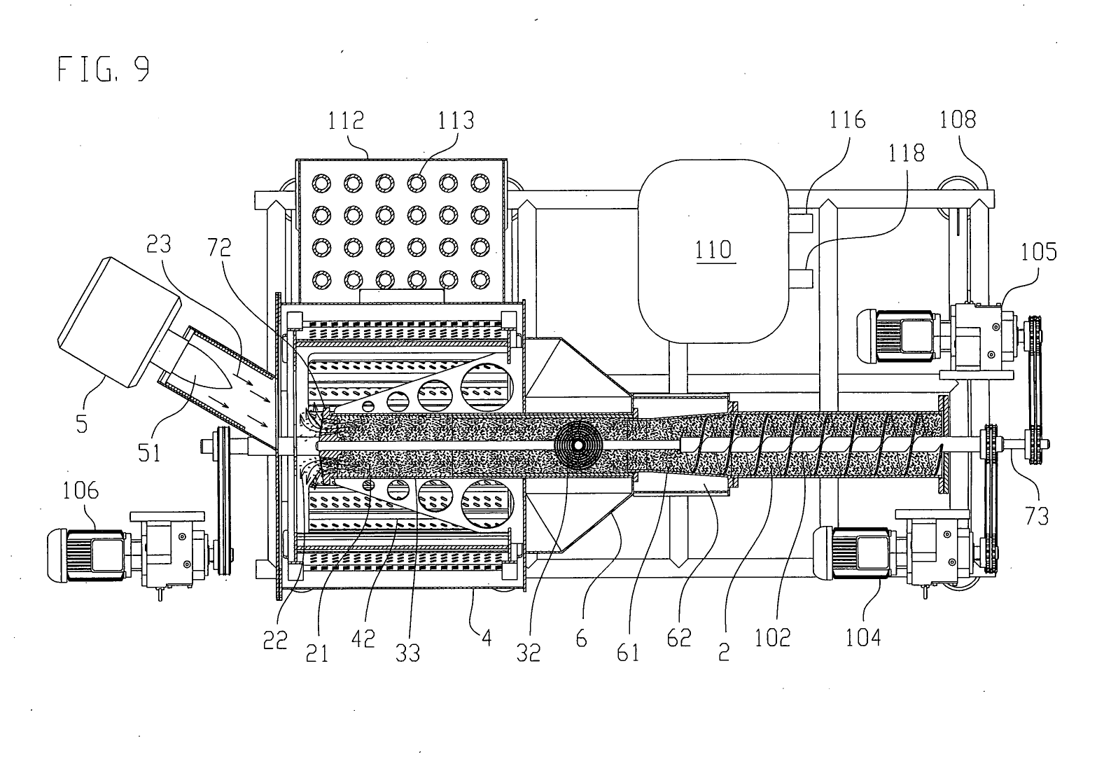

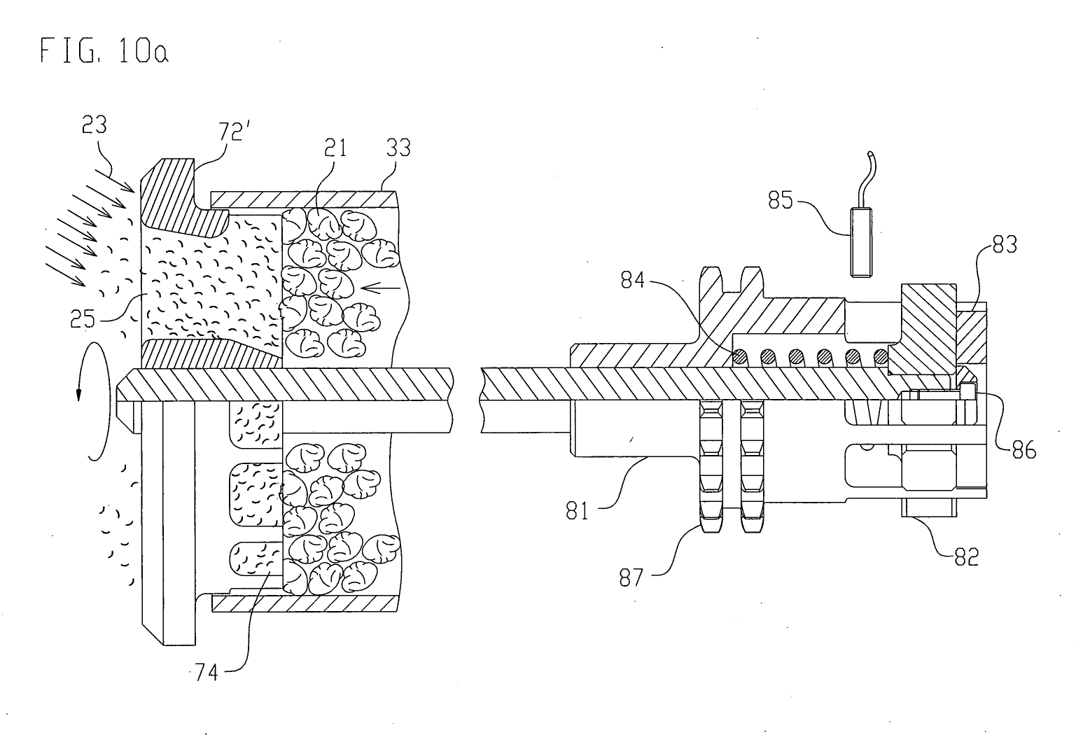

A further embodiment of a scraping unit is shown in FIGS. 8a, b in detail and as a component of the gas generator in FIG. 9. It is a rotating scraping part 72, which is situated at the outlet of the feed pipe 33. The scraping part 72 comprises a ceramic disc having windows 75 situated on its front side. In contrast to the scraping part 7 having blades 71 which is driven via the screen drum 42, the rotating scraping part 72 is driven via a shaft 73. Particles 25 are abraded from the nonvolatile pyrolysis products 21 by the rotational movement. They fly through the front window 75 out of the feed pipe 73 into the hot gas flow 23 of the plasma burner 5. Because the volatile pyrolysis products and the water steam also already arising during drying must also escape through the windows 75 out of the feed pipe 33, intensive gasification already occurs in the area of the windows 75, which act like small reactor chambers. The overall efficiency of the gas generator 1 is increased further.

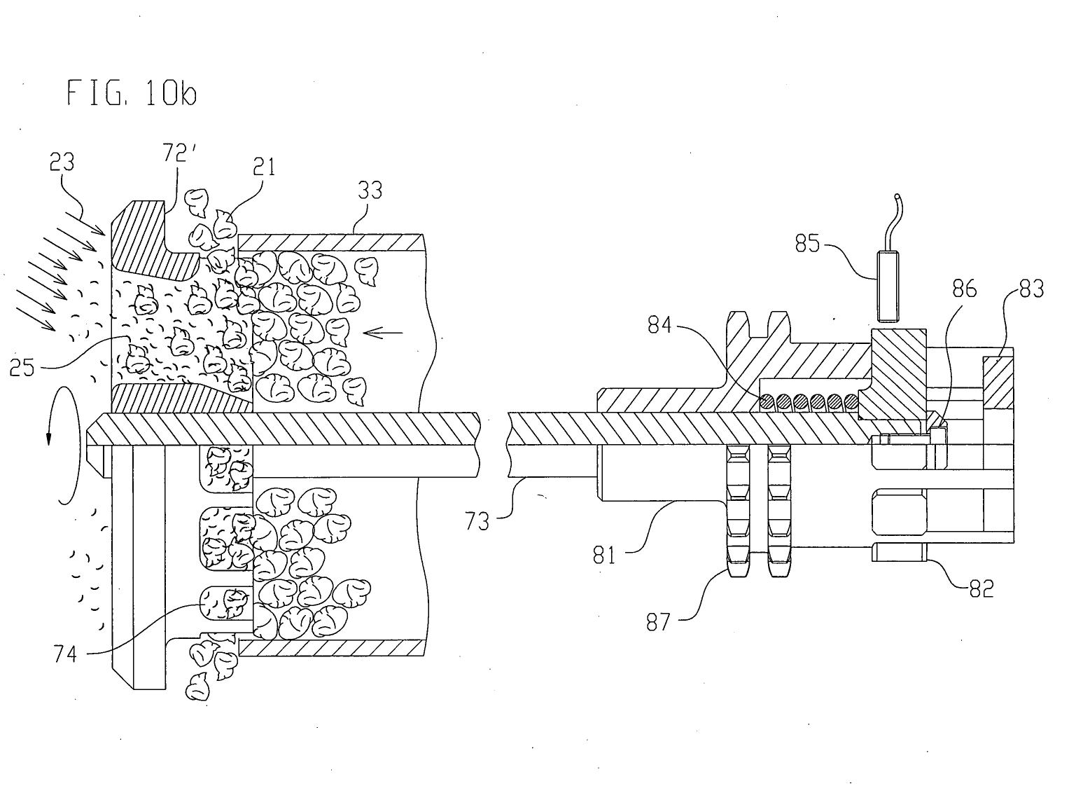

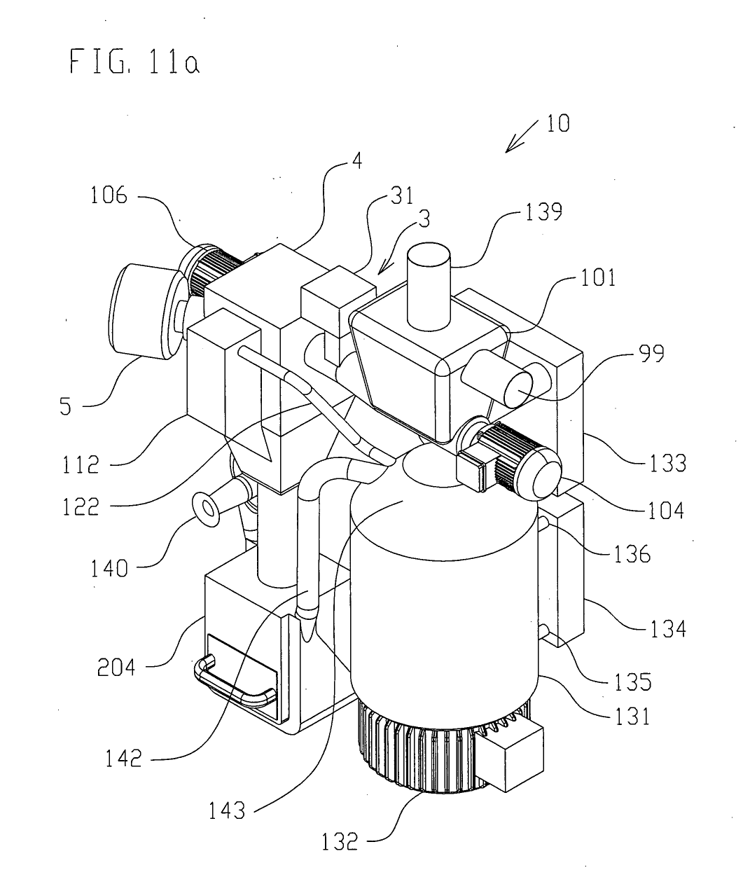

A special embodiment of a rotating scraping part is shown in FIGS. 10a, b. The rotating scraping part 72′ has radially situated windows 74 in addition to the windows situated on its front side. It rotates in the feed pipe 33 and is driven via the shaft 73 as above.

The drive 105 of the rotating scraping part 72′ essentially comprises a drive bushing 81 which is mounted so it is rotatable in a housing (not shown). The rotational movement is performed in the present example via a chain wheel 87. However, a gear wheel, a toothed belt, a wedge belt, or a similar part may also be used. The shaft 73 is radially guided in the drive bushing 81, but may move axially. A tappet star 82 is fastened friction-locked and/or formfitting at the right end of the shaft 73 and secured via a screw connection 86. The tappet star 82 engages in circularly situated grooves in the drive bushing 81. The rotational movement is thus transmitted from the drive bushing 81 to the shaft 73. The tappet star 82 may move axially within the grooves. The axial movement is limited on the right by a rear path limiter 83, which is screwed onto the drive bushing 81. The axial movement is possible to the left against the force of a spring 84 up to the end of the grooves in the drive bushing 81.

The normal operation of the rotating scraping part 72′ is shown in FIG. 10a. While it rotates, the tappet star 82 presses against the rear path limiter 83 and the radial windows 74 are covered by the walls of the feed pipe 33. In FIG. 10b, the axial pressure increases on the rotating scraping part 72′ due to an imminent clog of the feed pipe 73. If the axial force of the rotating scraping part 72′ exceeds the force of the spring 84, the rotating scraping part 72′ moves to the left in the drawing out of the feed pipe 33 and thus exposes the radially situated windows 74. Nonvolatile pyrolysis products 21 may now exit through the windows 74 from the feed pipe 33 and prevent it from clogging.

The axial position of the tappet star 82 may be defined by a sensor 85 in the area of the drive socket 81 and the danger of clogging may thus be counteracted via control of the input variables “speed of the scraping device” and “velocity of the material feed”. In addition, the path measurement of the tappet star 82 allows a determination of the wear state of the rotating scraping part 72.

The plasma burner 5 is a water-steam plasma burner in the present. example. The composition of the water-steam plasma encourages the gasification process very strongly, because it comprises the radicals O, H, OH, O₂, H₂, and H₂O at a mean temperature in the range of 4000° C. and peak values in the core of the plasma flame of approximately 12000° C. The enthalpy density of water steam is very high and the thermal efficiency of water steam sources is 70%-90%. In addition, water steam is easily available. Water-steam plasma therefore not only accelerates the gasification process, but rather is also advantageous from economic aspects.

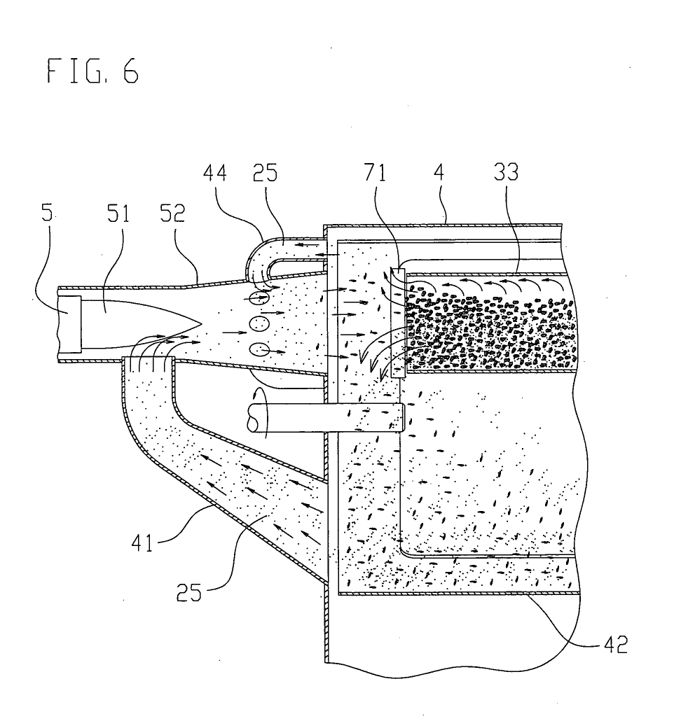

To reduce the dwell time of the particles 25 in the reactor 4 still further for the most complete possible gasification, a primary air circulation channel 41 is provided on the reactor 4 (see FIGS. 3, 6 in particular). The primary air circulation channel 41 connects the lower area of the reactor 4 to the connecting piece 52 of the water-steam plasma burner in the upper area of the reactor 4. A mixture made of gas 22, 23 located in the reactor 4 and particles 25 from the lower reactor area is sucked by the energy density of the plasma flame 51 via the primary air circulation channel 41. The mixture, at a temperature of approximately 750° C., arrives directly in the 4000° C. water-steam plasma flame 51 via a type of nozzle effect, because of which a strong volume enlargement of the gas results. This volume enlargement results in an acceleration of the gas mixture in the direction of reactor 4 with strong turbulence. The entry cross-section in the reactor 4 is implemented conically as a diffuser 52, to reinforce this procedure still further. Moreover, additional secondary air circulation channels 44 are provided, which conduct particles 25 from the upper inner chamber of the reactor 4 into the diffuser 52. The nozzle effect is also exploited again here. With the aid of the secondary air circulation channels 44, in addition to the action of the primary air circulation channel 41, better mixing of the reactor content is achieved in the upper reactor chamber. In addition, the gasification runs very intensively because of the especially high temperatures and high radical density in the plasma flame 51 and its immediate surroundings.

Notwithstanding the exploitation of the nozzle effect, this air circulation principle may also be achieved mechanically or with the aid of fans, or these measures may be combined with the nozzle effect. One skilled in the art will decide this as a function of the geometry of the device, the operating parameters of the plasma source 5 or other external heat introduction sources.

In the reactor 4, the mixture made of gas and particles exiting from the diffuser 52 is incident on the scraping unit 7 and the surface of the supplied pyrolysis products 21, possibly also the carbonaceous material 2, and heats them to the processing temperature. The mixture subsequently flows into the lateral upper area of the screen drum 42 and mixes with the material continuously conveyed upward by the screen drum. Not only is a continuous gasification process thus maintained. The gasification process also runs more rapidly due to this air circulation system.

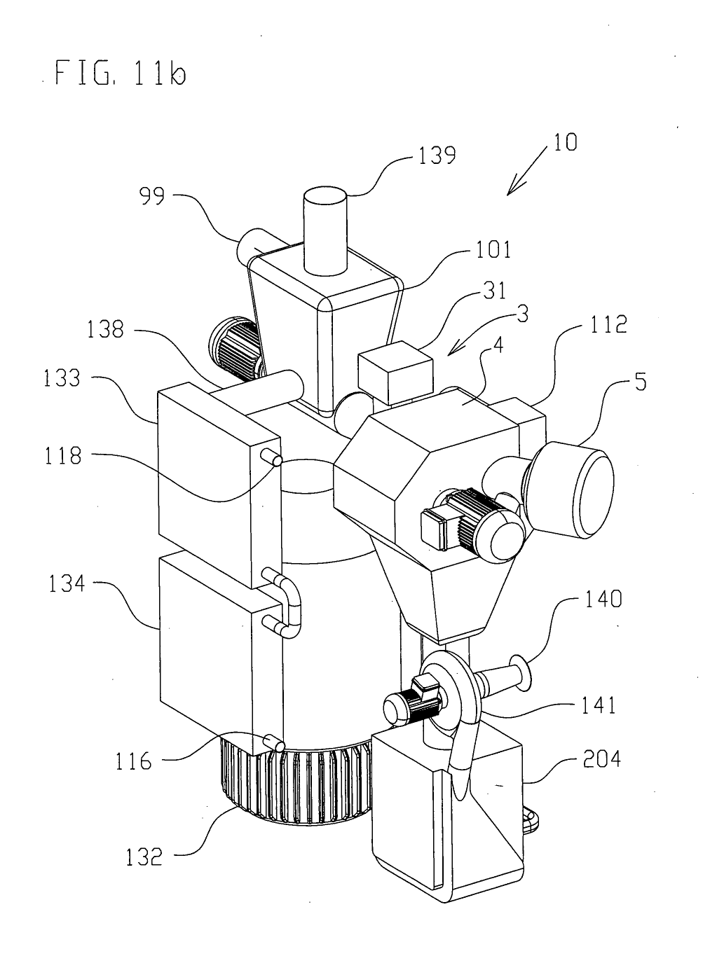

All of these measures result in a very strongly shortened dwell time of the material to be gasified. The primary reactor 4 in particular may thus be dimensioned significantly smaller, which has the result that the insulation losses are strongly reduced and the overall efficiency may be significantly increased. The overall size of the gas generator may be decreased so strongly that in addition to facilities in the output range of approximately 100 kWₑₗ (net) or more, small facilities for the residential field in the output range of approximately 2-4 kWₑₗ (net) are possible (see below, FIGS. 11a-c).

The ash 24 arising during the gasification is screened out by the screen drum 42 and falls into the lowermost area of the primary reactor 4 (see, inter alia, FIG. 4). An ash outlet 114 is located there, through which the ashes 24 are removed (reference numeral 203 in FIG. 7). The remaining gasification products 23 are drawn off via the lower reactor area using a slight partial vacuum with the aid of a fan 128 from the reactor inner chamber to a filter unit 112. This advantageously comprises ceramic filter cartridges 113, which may be integrated in the reactor housing. The ceramic filter cartridges 113 are used as a dust filter and have the advantage that the generated gas may be filtered without prior cooling, i.e., while still at approximately 700°-800° C.

The filter unit 112 and the reactor 4 share an external wall in the present example (see FIG. 4). This has the special advantage that on one hand the reactor 4 is especially well thermally insulated on this side and on the other hand the filter unit 112 is preheated by the reactor waste heat to operating temperature. In addition, the filter unit 112 and the reactor 4 share the ash outlet 114, which simplifies the cleaning of the filter unit 112.

After the filtering, the generated hot gas may be fed directly to an engine which may be operated using hot gas for power generation or also to a pore burner. In the present example, the hot gas is guided via a line 122 to a further station 120, which has the function of a gas-water heat exchanger and/or a washer. The hot gas may thus be cooled to below 50° C. and cleaned. In addition, the heat may be used in that the heated coolant water which is supplied via the inlet 116 and removed via the outlet 118 is fed with the aid of a pump 126 into the building services systems or relayed to an external heat exchanger. The heat may also be used for preheating the carbonaceous material 2. The cooled clean gas is drawn off with the aid of a fan 128 from the system via a partial vacuum and discharged into an external gas store or a block heating power plant for further use.

A further embodiment of a gas generator is shown in FIGS. 11a-c. This gas generator is designed for a power of approximately 2-4 kWₑₗ or 8-16 kWₜₕₑᵣₘ and is therefore suitable for use in the residential field. Because the internal construction of this gas generator does not significantly differ from the gas generator 1 already explained, an internal view is dispensed with and only the deviating components are discussed, to which the gas generator in this example is connected.

A household facility 10 for generating heat and electrical energy is shown in FIGS. 11a-c. The household facility 10 is a complete module which essentially comprises a gas generator and an engine connected thereto as a generator drive. The household facility generates gas containing CO and H₂ from carbonaceous materials as previously described via a pyrolysis with the aid of the microwave generator 31 and a heating unit (not visible here) and gasification via subsequent external heat introduction, here using a water-steam plasma source. This gas is used for driving a Stirling engine 131, which drives a generator 132, by which power is generated. The waste heat is used for heating residential buildings and for generating hot water.

The carbonaceous materials are supplied through the connecting pieces 99 with the aid of fans or screws, for example, and reach the double-walled funnel 101 here. After pyrolysis using microwave and thermal irradiation and water-steam plasma gasification as previously described, the gas containing CO and H₂ exits at a temperature of greater than 400° C. from the filter unit 112 made of ceramic filter cartridges and is guided through the gas pipe 122 into the hot gas burner 143, in the form of a pore burner here. It is combusted therein with the combustion air, which is suctioned via an inlet nozzle 140 by a fan 141 for noise reduction, in the hot gas burner 143. The combustion intake air is previously conducted through the ash compartment 204, implemented as double-walled here, because of which the air heats up and the ash cools down. The risk of fire upon ash disposal is thus minimized. The combustion intake air is guided from the ash compartment 204 via the line 142 to the hot gas burner 143.

The heat energy (approximately 1050°-1100° C.) generated in the hot gas burner 143 is used for driving the Stirling engine 131. This drives the generator 132, so that power is generated. The energy to be dissipated which results from the Stirling process is introduced via a coolant water outlet 135 into a water/water heat exchanger 134. The cooled-down water (ΔT approximately 40-50° C.) is introduced back into the Stirling engine 131 via the coolant water inlet 136. The hot exhaust gases (approximately 600-700° C.) from the hot gas burner 143 are fed via a line 137 to a gas/water heat exchanger 133. After flowing through the gas/water heat exchanger 133, the exhaust gases reach the funnel 101 via a line 138 and heat the carbonaceous materials introduced therein through the connecting pieces 99. The exhaust gases reach the flue of the building at a temperature of approximately 50° C. via a pipe connection 139. The waste heat from the heat exchangers 133, 134 is fed via a coolant water inlet 116 and a coolant water outlet 118 into the building's heating installation and the hot water preparation.

The advantages of the domestic facility 10 may be seen in that carbonaceous materials such as pellets, green wastes, household waste, etc., may be used for the power supply of residential buildings. In addition to the necessary room heating and hot water preparation, electrical current is generated, which is fed into the power network in the idle times and credited. This decreases the energy cost of the individual households and contributes to decentralization of the power market. Devices from the size of floor heaters up to multifamily houses may be implemented by the compact overall size of the gas generator. No tars may precipitate due to the combustion of the gas at temperatures above 500° C., so that the gas cleaning may be restricted to the dust filter 112 using ceramic filter cartridges.

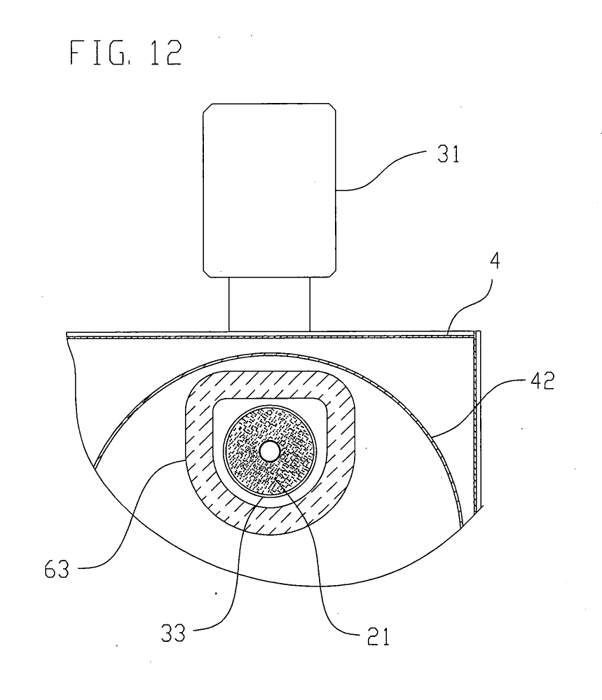

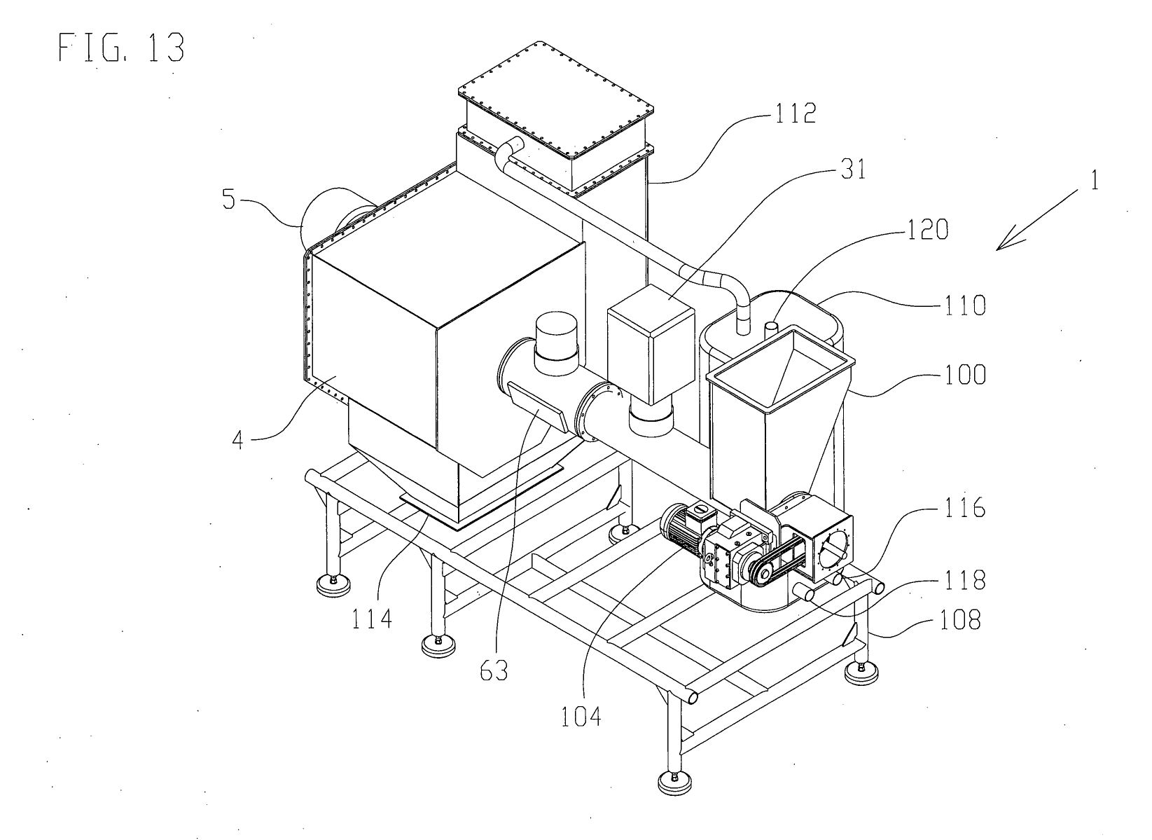

The third device for gas generation shown in FIG. 13 differs from the first device shown in FIG. 1 in particular in regard to the design of the pyrolysis station. While in the first device the material to be pyrolyzed is first heated with the aid of the heating unit from the outside to the inside after the compaction before it is irradiated using microwaves, to also heat it from the inside to the outside (see also FIGS. 2 and 3), in the third device, the material to be pyrolyzed is first irradiated using microwaves of the microwave generator 31 to achieve the pyrolysis temperature in the interior, and subsequently guided through a heating unit, in this example a pore furnace 63, to also bring the material to pyrolysis temperature from the outside to the inside.

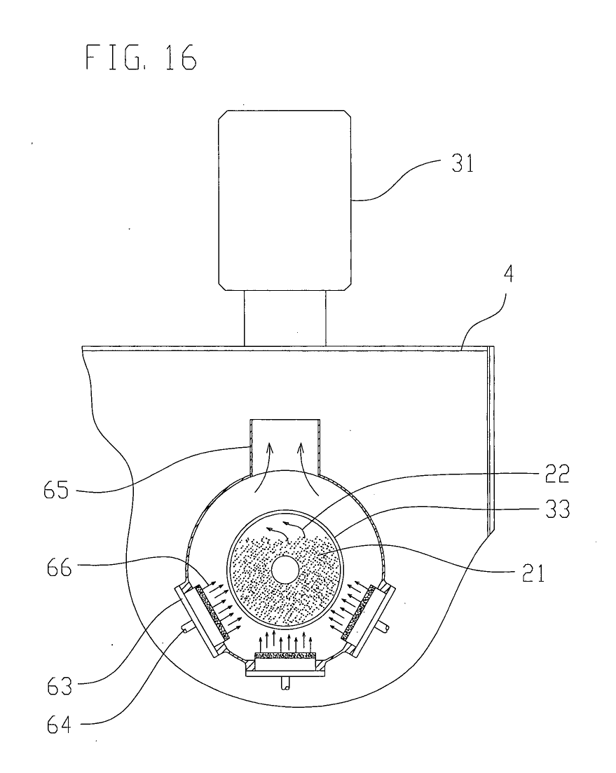

A vertical section through the device from FIG. 13 at the height of the pore burner 63 is shown in FIG. 16. In contrast to the example shown in FIG. 12, in this example the microwave station is combined with three pore burners 63 for more intensive pyrolysis, which adjoin the microwave generator 31 and are situated around the feed pipe 33 in the area of its lower periphery, so that the radiant heat 66 radiates on the feed pipe 33. The pore burner 63 may be fired using synthesis gas containing CO and H₂ generated in the gas generator, which is fed via the synthesis gas connections 64. The synthesis gas is combusted together with air and/or oxygen in the pore area of the pore burners 63 while generating heat energy. The exhaust gases arising exit through the exhaust gas outlet 65 and may be used for preheating other components. The pore area is generally formed by ceramic foam or another structure resistant to high temperatures. Their very high power density of approximately 1000 kW/m² is a special advantage of pore burners. In particular, high temperatures of up to approximately 1400° C. may be achieved. Further advantages are high heating rates and good ability to regulate the furnace temperature. Because pore burners allow very high gas temperatures, gas generated during the gasification procedure may be fed immediately thereto without prior cooling, possibly after dust filtering. In the example shown in FIG. 16, the pore burner 63 achieved six times as high a heat introduction as a typical gas burner. Overall, the use of a pore burner in combination with microwave pyrolysis improves the overall energy balance of the gas burner while nonetheless requiring little space and is therefore also suitable in particular for gas generators which are dimensioned for household use.

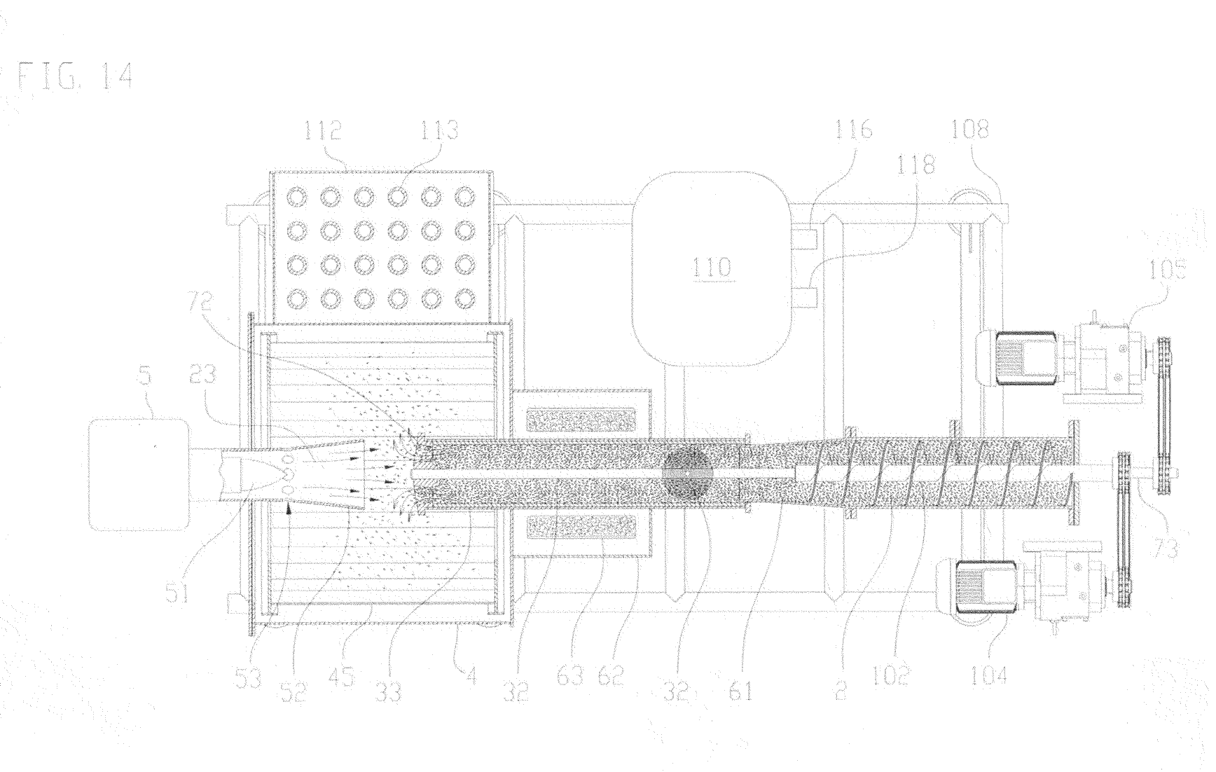

Furthermore, several differences from the first device exist in the gasification reactor 4 of the third device (see FIG. 14): the feed pipe 33 for feeding the pyrolyzed material and the plasma burner 5 are situated in relation to one another in such a way that the hot gas flow generated by the plasma flame 51 is incident not only laterally, but rather also frontally on the scraping unit 72 (see also FIGS. 8a, b), to heat up the scraping unit 72 still better. During the scraping, the scraping unit 72 transfers its temperature to the material to be comminuted. Due to the frontal orientation of the hot gas flow 23 on the scraping unit 72, in addition, the hot gas flow also better directly heats the material to be comminued to processing temperature for the gasification in the front windows 75 of the scraping unit 72.

The heating of the pyrolysis products immediately after the pyrolysis, when they are at a very high temperature because of the pore burner, has the result that gasification already begins to occur in the feed pipe 33 toward its outlet on the gasification reactor side. Gasification already partially also occurs in the front windows 75 of the scraping unit 72.

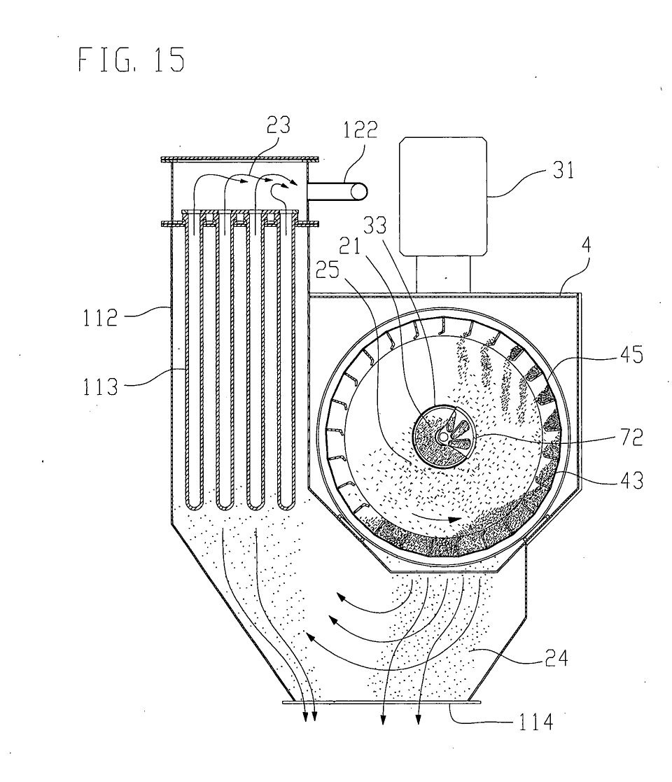

The advantage of this smooth transition from pyrolysis to gasification is that the solid pyrolysis products are gasified very efficiently and only little ash remains. Therefore, in the second device shown here, the drum 45 is also not implemented as a screen drum, but rather only as a drum 45 having drum panels 43 (see FIG. 15), to introduce particles 25 which have not yet been gasified back into the hot gas flow. The little ash 24 may exit via the front faces of the drum 45 and be removed via the ash outlet 114. The drum 45, which is not implemented as a screen drum, has the additional advantage of more efficient thermal insulation of the inner chamber of the gasification reactor 4.

The plasma flame 51 is situated in the second device in a diffuser 52 provided with openings 53 (see FIG. 14). In the water-steam plasma flame 51, the volatile and solid pyrolysis products come together with the radicals generated therein, with which they react to form CO and H₂. Moreover, they are heated very strongly very rapidly in the plasma, so that a sudden volume expansion occurs, which results in a local partial vacuum. Further pyrolysis products are sucked into the water-steam plasma flame 51 through the openings 53 via this local partial vacuum, so that a continuous hot gas flow is maintained.

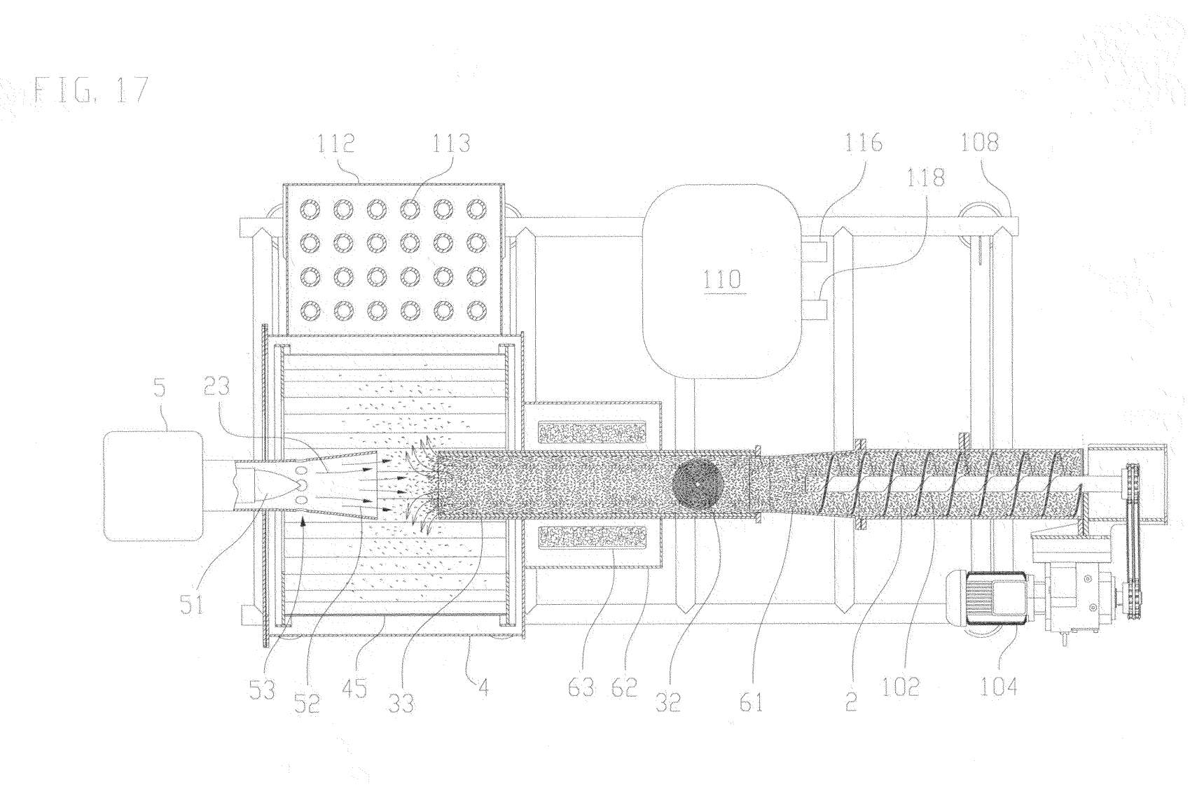

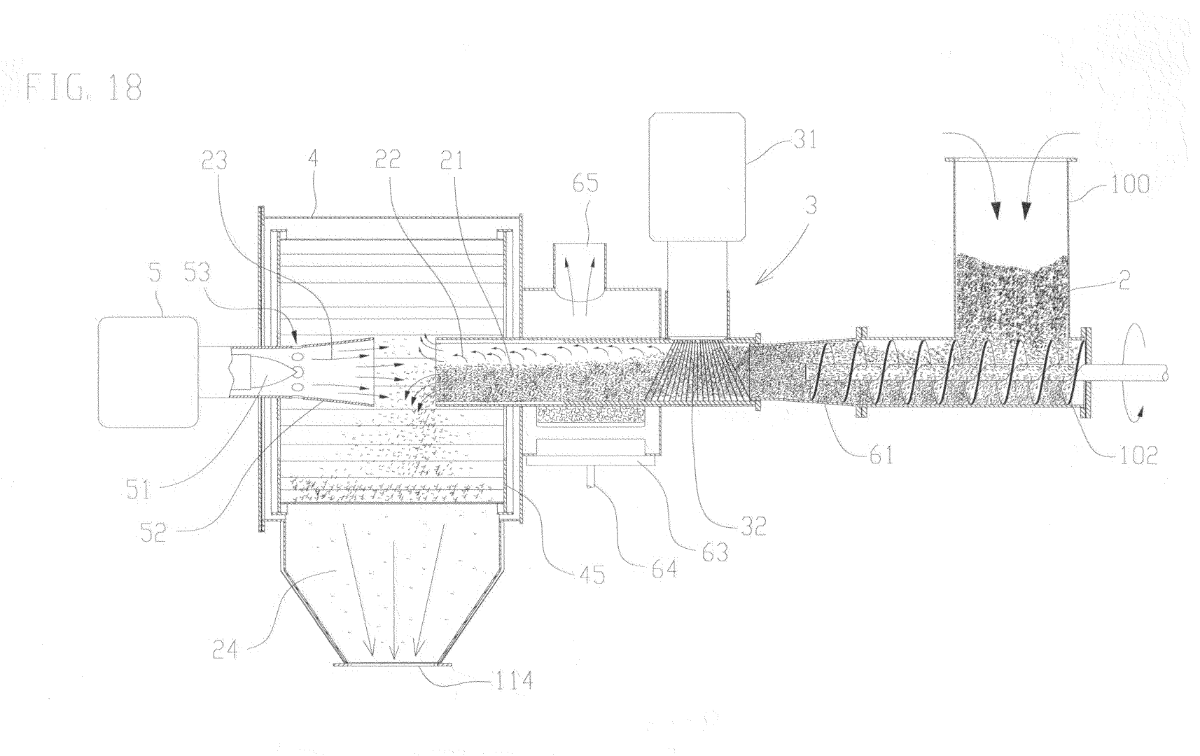

Due to the shortening of the feed pipe 33 and the projection of the plasma burner 5 into the gasification reactor 4, the space required is reduced further for the third device in comparison to the first device. It is to be noted that the third device for gas generation from FIGS. 13 through 16 may also be implemented having the scraping unit 72 as in FIGS. 8a, b or also having blades 71 as in FIG. 4 or another scraping unit. It is also possible to provide the third device entirely without a comminuting unit, as shown in FIGS. 17 and 18. Depending on the selection of the carbonaceous material, due to the especially efficient pyrolysis presented here, the solid pyrolysis products may be so friable that they do not require additional comminuting. Because the hot gas flow 23 is additionally directly incident on the pyrolysis products when they enter into the reactor 4, they are brought in a minimal time to a sufficiently high temperature for low-residue gasification.

Furthermore, it is to be noted that the third device for gas generation was also described in a device for power generation as with reference to FIGS. 11a-c, for example.

### LIST OF REFERENCE NUMERALS

1 gas generator
10 household facility
2 carbonaceous material
21 nonvolatile pyrolysis products
22 volatile pyrolysis products
23 hot gas flow
24 ash
25 abraded particles
3 microwave station
31 microwave generator
32 microwave zone
33 feed pipe
4 primary reactor
41 primary air circulation channel
42 screen drum
43 screen drum panel
44 secondary air circulation channel
45 drum
5 plasma burner
51 plasma flame
52 diffuser
53 opening
64 gas connection
65 exhaust gas outlet
66 radiant heat
6 secondary reactor
61 squeezing part
62 heater
63 pore burner
7 scraping unit
71 blade
72, 72′ rotating scraping part
74 radially situated window
75 frontally situated window
81 drive bushing
82 tappet star
83 rear path limiter
84 spring
85 sensor
86 screw connection
87 chain wheel
99 connecting piece
100 funnel
101 funnel (with surrounding exhaust gas flow)
102 transport screw
104 drive transport screw
105 drive rotating scraping device
106 drive screen drum
108 support
110 heat exchanger/washer
112 filter unit
113 ceramic filter cartridge
114 ash outlet
116 coolant water inlet
118 coolant water outlet
120 clean gas outlet
122 gas line
124 feed into building services system/external heat exchanger
126 pump
128 fan
130 external gas store/block heating power plant/engine
131 Stirling engine
132 generator
133 gas/water heat exchanger
134 water/water heat exchanger
135 coolant water outlet
136 coolant water inlet
137 line
138 line
139 pipe connection
140 intake nozzle
141 fan
142 combustion air line
143 hot gas burner
201 preheating
203 ash disposal
204 ash compartment

What is claimed is:

1. A method for gasifying carbonaceous material into gas containing CO and H₂ having upstream pyrolysis, comprising the steps of: performing the pyrolysis of the carbonaceous material with the aid of microwave irradiation and by thermal irradiation of the carbonaceous material, and allothermally performing gasification of the pyrolysis products with the aid of a water-steam plasma.

2. The method according to claim 1, wherein the thermal irradiation of the carbonaceous material is performed with the aid of a pore burner.

3. The method according to claim 1, wherein the gasification immediately follows the pyrolysis.

4. The method according to claim 1, wherein the pyrolysis products or the carbonaceous material or gasification products or a combination thereof are at least partially subjected to the water-steam plasma more than once.

5. The method according to claim 1, wherein the carbonaceous material is compacted before or during or after or a combination thereof the microwave irradiation.

6. The method according to claim 1, wherein the pyrolysis products or the carbonaceous material or a combination thereof are comminuted after the microwave irradiation.

7. A device for gasifying carbonaceous material into gas containing CO and H₂, comprising: at least one microwave station and one heating unit to at least partially perform a pyrolysis of the carbonaceous material, as well as a first reactor having at least one water-steam plasma burner to perform the gasification.

8. The device according to claim 7, wherein the microwave station or the heating unit is situated in a process flow direction directly before the first reactor.

9. The device according to claim 7, wherein the microwave station is situated in a second reactor.

10. The device according to claim 7, wherein the microwave station has a compaction unit.

11. The device according to claim 10, wherein the heating unit is implemented as a pore burner.

12. The device according to claim 7, wherein a mixing unit is situated in the first reactor.

13. The device according to claim 12, wherein the mixing unit is implemented as a rotatable screen drum.

14. The device according to claim 7, wherein a comminuting unit is situated in the first reactor or at an outlet of the microwave station.

15. The device according to claim 14, wherein the comminuting unit is implemented as a scraping unit which abrades the surface of the pyrolysis products or carbonaceous material or any combination thereof which exit(s) from the microwave station.

16. The device according to claim 14, wherein a mixing unit is situated in the first reactor and the mixing unit is implemented as a rotatable screen drum, and wherein the comminuting device is situated on the screen drum.

17. The device according to claim 7, wherein the at least one water-steam plasma burner is attached to the first reactor in such a way that its plasma flame does not or only partially extends up into the reactor inner chamber, and an additional duct leads from the first reactor to the plasma flame, through which a reactor content is sucked toward the plasma flame.

18. A device for generating electrical energy using pyrolysis and gasification of carbonaceous materials into gas containing CO and H₂, comprising: a gasification reactor, an engine driven with the aid of the gas containing CO and H₂, and a power generator driven by the engine, wherein at least one microwave station and one heating unit are connected upstream from the gasification reactor, in which the carbonaceous material is at least partially pyrolyzed using microwave irradiation and thermal irradiation, and the gasification reactor has a water-steam plasma burner as a heat source.

19. The device according to claim 18, wherein the heating device is implemented as a pore burner.

20. The device according to claim 18, wherein the microwave station or the heating unit is arranged immediately before the first gasification reactor in a process flow direction.

21. The device according to claim 18, wherein a hot gas burner is connected upstream from the engine and the engine is implemented as a Stirling engine.

22. The device according to claim 21, wherein the hot gas burner is implemented as a pore burner.
